(19) United States
(12) Patent Application Publication
(10) Pub. No.: US 2016/0215558 A1
(43) Pub. Date: Jul. 28, 2016

(54) UNIT CELLS, BLIND JOINING SAID UNIT CELLS, AND BLIND ASSEMBLY COMPRISING SAID BLIND

(71) Applicant: WINPLUS CO., LTD., Chungcheongbuk-do (KR)

(72) Inventor: Tae-Woong Byun, Daejeon (KR)

(21) Appl. No.: 14/915,214

(22) PCT Filed: Aug. 28, 2014
(86) PCT No.: PCT/KR2014/008040

§ 371 Date: Feb. 26, 2016

(30) Foreign Application Priority Data
Aug. 29, 2013 (KR) 10-2013-0103402
Jul. 29, 2014 (KR) 10-2014-0096359

(51) Int. Cl. E06B 9/262; E06B 9/386

(52) U.S. Cl. CPC E06B 9/262; E06B 9/386; E06B 2009/2627; E06B 2009/2405

(57) ABSTRACT

A unit cell for a blind comprises an opaque portion; a pair of translucent portions which are respectively connected to both ends of the opaque portion and arranged opposite each other with respect to the opaque portion; and a pair of joining portions which are respectively connected to each end of the pair of translucent portions, wherein the translucent portions of the unit cell are foldable along a substantially center portion thereof.

### TECHNICAL FIELD

The present invention relates to unit cells, a blind formed of the unit cells joined to each other, and a blind assembly comprising the blind. More specifically, the present invention relates to unit cells which are foldable along a center portion thereof, and a blind formed of the unit cells which are joined to each other which allows or blocks penetration of light by adjusting an angle.

### BACKGROUND ART

In general, blinds are installed to a window or entrance of a building for the purpose of interruption of light, protection of privacy, insulation of sound, protection against cold, or the like. In addition to the above purposes, the blinds are used as a major element in interior design to improve indoor aesthetic by a color scheme which can be in harmony with an inner wall or window glass.

The blind includes a vertical blind consisting of a plurality of segments and being able to adjust a slope of the segment, and a roll screen blind consisting of a winding rod and one- or two-fold blind fabric wound around or unwound from the rotating winding rod. Also, the blind may include a honeycomb-type blind consisting of a plurality of honeycomb-shaped unit cells which are joined to each other and are folded or unfolded, and a Roman shade blind consisting of a blind fabric which is folded in a vertical direction by the winding operation of a loop cord for adjusting its length.

U.S. Pat. No. 4,450,027 discloses a kind of honeycomb-type blind. A honeycomb-shaped unit cell constituting the blind can be made of fabric or film material. However, the blind has a problem in that only a height of the blind can be adjusted by folding or unfolding the unit cells, and an angle of the unit cell cannot be adjusted. As a result, it is not possible to adjust the amount of light entering through the window.

U.S. Pat. No. 6,112,797 solves the problem of U.S. Pat. No. 4,450,027 in that the blind cannot adjust the amount of the light. The blind disclosed in the patent includes a vane 100 made of an opaque material, as illustrated in FIG. 1, and an adhesive is applied to an upper end 110 and a lower end 120 of both sides of the vane. FIG. 2 shows the blind in a fully opened state. Referring to FIG. 2, the blind includes a first fabric 130 made of a translucent fabric, a second fabric 132 made of a translucent fabric, and an opaque vane 100 formed between the first and second fabrics. The vane is adhered to the first fabric and the second fabric of the blind by the adhesive applied to the upper end 110 and the lower end 120 thereof. The vane has a center portion 140 which is almost perpendicular to the first and second fabrics. An edge 142 of the vane is connected to the center portion 140 by a smoothly bent portion 141. As illustrated in FIG. 2, in the state of the fully opened blind, light can enter inside through the translucent fabrics 130 and 132. Also, in the fully opened state, the vane can maintain a restoring force due to the feature of the vane being smoothly bent. As a result, the fabrics are deflected to a closed or pulled position. Such a feature can maintain the shape even after repeated openings and closings of the blind.

FIG. 3 is a perspective view illustrating the operation of the blind according to the related art. FIG. 3 shows that a blind 150 is wound around a head roller 152 by manipulation of an adjusting cord. Rotation of the head roller causes relative movement between the first fabric 130 and the second fabric 132 in a longitudinal direction. And thus, an angular change in the orientation of the opaque vane 100 lets in or blocks out the light. In the drawing, a reference numeral 153 indicates a weight, and 154 indicates a decorative stiffener. The blind disclosed in the patent can regulate the amount of the light by the angular change in the orientation of the vane in the state in which the blind is fully unwound, i.e., when the lower end of the blind is positioned at a bottom dead point.

### DISCLOSURE

### Technical Problem

An object of the present invention is to provide a unit cell which can be folded along a substantially center portion of translucent portions thereof.

Another object of the present invention is to provide a blind which can adjust an angle of an opaque portion by relative movement between the translucent portions of the unit cell.

In addition, a further object of the present invention is to provide a blind of which the unit cell is folded in order from the lowermost unit cell positioned at a lower end of the blind when the blind is raised.

Further, another object of the present invention is to provide a blind assembly having a smaller frame size since the blind is not wound around a roller.

### Technical Solution

To accomplish the above-mentioned object, according to a first aspect of the present invention, there is provided a unit cell for a blind, comprising: an opaque portion; a pair of translucent portions which are respectively connected to both ends of the opaque portion and arranged opposite each other with respect to the opaque portion; and a pair of joining portions which are respectively connected to each end of the pair of translucent portions, wherein the translucent portions of the unit cell are foldable along a substantially center portion thereof.

Preferably, the opaque portion is formed by laminating an opaque fabric member on a translucent fabric member.

Preferably, the opaque portion is formed by performing a film laminating process on a translucent fabric member.

Preferably, the opaque portion is formed by performing a printing process on a translucent fabric member.

Preferably, the printing process is at least one of a pigment printing process and a foaming printing process.

Preferably, the translucent portions are made of a translucent fabric member, the opaque portion is made of an opaque fabric member, and the translucent fabric member and the opaque fabric member are made of weft yarns and/or warp yarns of different intersection intervals and/or a different thickness.

Preferably, the joining portions of the unit cell are bonded to an opaque portion of another unit cell.

Preferably, the translucent portions of the unit cell have a folding line at the substantially center portion thereof so that the translucent portion is easily folded.

Preferably, the folding line is formed by pressing.

Preferably, the folding line is formed by skipping a weft yarn.

Preferably, the folding line is formed by weaving a thread thinner than that of the translucent portion.

According to another aspect of the present invention, there is provided a blind capable of adjusting a horizontal angle comprising: a plurality of unit cells, each unit cell including: an opaque portion; a pair of translucent portions which are respectively connected to both ends of the opaque portion and arranged opposite each other with respect to the opaque portion; and a pair of joining portions which are respectively connected to each end of the pair of translucent portions, wherein the blind is formed by bonding the joining portions of the unit cell to an opaque portion of another unit cell, wherein an angle of the opaque portion is adjusted in a horizontal direction by relative movement between the pair of translucent portions, and wherein when the blind is raised the translucent portions of the unit cells are folded along a substantially center portion thereof and the unit cells are stacked in order from the lowermost unit cell.

Preferably, the translucent portions of the unit cell have a folding line at the substantially center portion thereof so that the translucent portions are easily folded.

According to another aspect of the present invention, there is provided a blind assembly comprising: a blind; a frame for mounting the blind; an angle adjusting member and a drum which are installed to an inside of the frame; and a driving device for driving the angle adjusting member and the drum, the blind including a plurality of unit cells, each unit cell comprising: an opaque portion, a pair of translucent portions which are respectively connected to both ends of the opaque portion and arranged opposite to each other with respect to the opaque portion, and a pair of joining portions which are respectively connected to each end of the pair of translucent portions, wherein the blind is formed by bonding the joining portions of the unit cell to an opaque portion of another unit cell, wherein an angle of the opaque portion is adjusted in a horizontal direction by relative movement between the pair of translucent portions, and wherein when the blind is raised the translucent portions of the unit cells are folded along a substantially center portion thereof and the unit cells are stacked in order from the lowermost unit cell.

Preferably, the opaque portion of the unit cell is formed with a through-hole through which a lift cord passes.

Preferably, the opaque portion of the unit cell has at least two the through-holes.

Preferably, the translucent portions of the unit cell have a folding line at the substantially center portion thereof so that the translucent portions are easily folded.

### Advantageous Effects

The present invention can pass or block light since the angle of the opaque portion is adjusted by the relative movement between the translucent portions of the unit cell.

Also, the unit cells are folded and stacked in order from the lowermost unit cell positioned at a lower end of the blind when the blind is raised. Accordingly, it is possible to pass the light by angular adjustment of the unit cells that are not folded when in a state in which the blind is raised to a certain extent.

In addition, it is possible to provide a blind assembly having a smaller frame size since the blind is not wound around the roller.

### DESCRIPTION OF DRAWINGS

FIG. 1 is a view illustrating a vane of a blind according to the related art, in which an adhesive is applied to an upper end and a lower end of both sides of the vane.

FIG. 2 is a perspective view of a blind according to the related art, in which the blind is in a fully opened state.

FIG. 3 is a perspective view of a blind according to the related art to show operation of the blind.

FIG. 4 is a perspective view illustrating unit cells and a blind formed by joining the unit cells according to one embodiment of the present invention.

FIG. 5 is a perspective view illustrating unit cells and a blind formed by joining the unit cells according to another embodiment of the present invention.

FIGS. 6a and 6b are views illustrating a method of forming folding lines according to the present invention.

FIG. 7 is a view schematically illustrating a method of fabricating a unit cell according to one embodiment of the present invention.

FIG. 8 is a perspective view illustrating a unit cell according to another embodiment of the present invention.

FIG. 9 is a view schematically illustrating a method of fabricating a unit cell according to another embodiment of the present invention.

FIG. 10 is a view schematically illustrating a method of fabricating a unit cell according to another embodiment of the present invention, in which the unit cell has a translucent portion of a different color.

FIG. 11 is a view schematically illustrating a method of fabricating a unit cell according to another embodiment of the present invention, in which the unit cell has a translucent portion of a different color.

FIG. 12 is a view schematically illustrating a method of fabricating a unit cell according to another embodiment of the present invention.

FIG. 13 is a view schematically illustrating a method of fabricating a unit cell according to another embodiment of the present invention.

FIG. 14 is a longitudinal cross-sectional view schematically illustrating a blind assembly using the blind according to one embodiment of the present invention.

FIGS. 15a and 15b are views schematically illustrating lifting and lowering operation of the blind assembly according to one embodiment of the present invention.

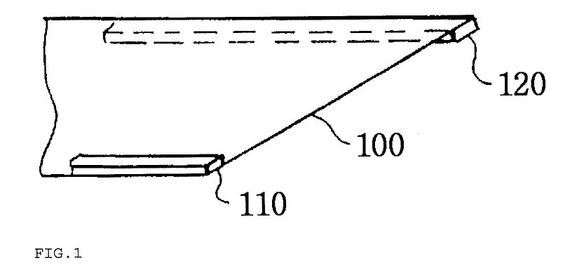

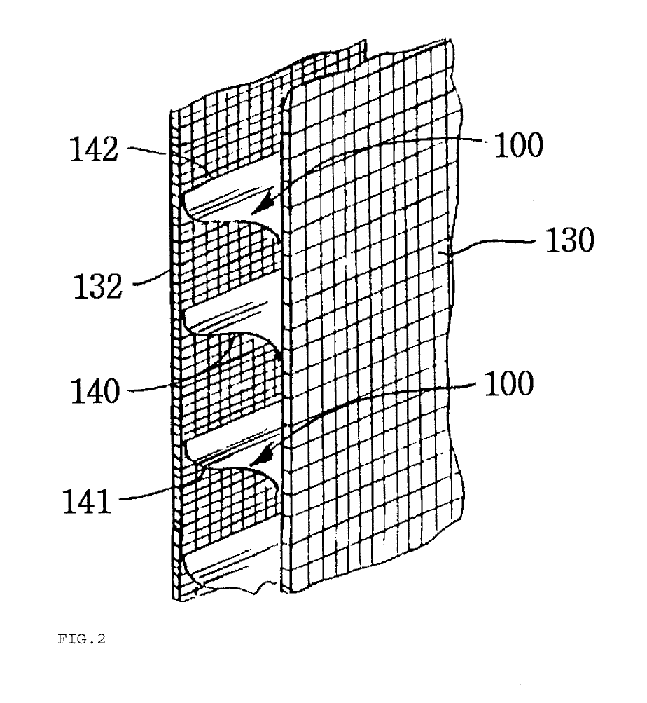

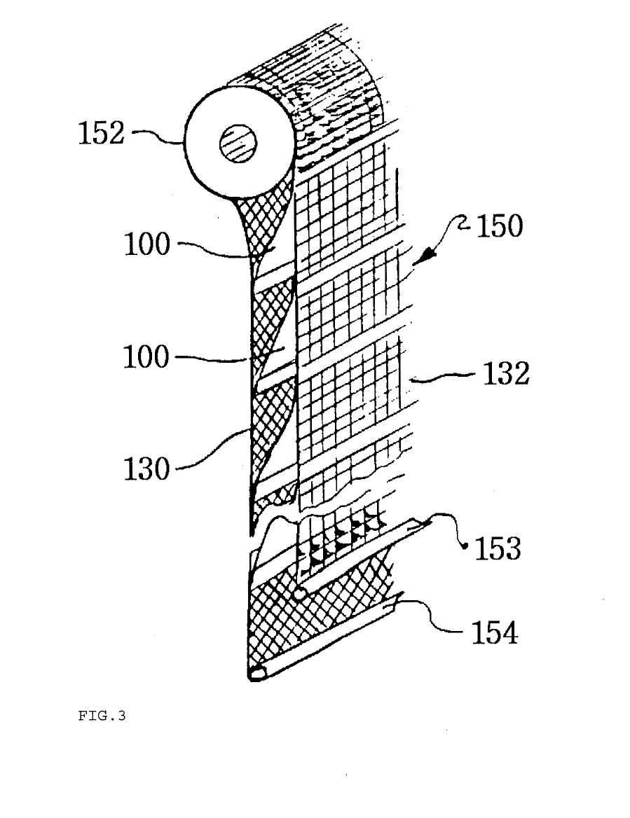

### MODE FOR INVENTION

The objects, features and advantageous effects as stated above will be made more apparent through the following embodiments, which will be described with reference to the accompanying drawings.

The specific configurations and functional descriptions are merely exemplary for describing the embodiments according to the present invention, and further the embodiments of the present invention may be implemented in various ways, and thus should not be construed as limiting thereto.

The embodiments according to the principles of the present invention may be changed variously and have various implementations and thus the specific embodiments will be illustrated in the drawings and described in the specification. However, the embodiments according to the principles of the present invention are not limited to the specifically disclosed implementations and thus it should be understood that it includes all modifications, equivalents or replacements within the spirit and scope of the present invention.

The terminology used herein is for the purpose of describing particular embodiments only and is not intended to be limiting to the embodiments. As used herein, unless otherwise defined, the singular forms “a,” “an” and “the” are intended to include the plural forms as well. Unless the context indicates otherwise, it will be further understood that the terms “comprising” and/or “having” when used in this specification, specify the presence of stated features, integers, steps, operations, components, parts, or combinations thereof, but do not preclude the presence or addition of one or more other features, integers, steps, operations, components, parts, or combinations thereof.

Unless otherwise defined, all terms including technical or scientific terminology used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the preferred embodiments of the present invention will be described in detail referring to the drawings. In the drawings, the same reference numerals refer to the same components unless otherwise indicated.

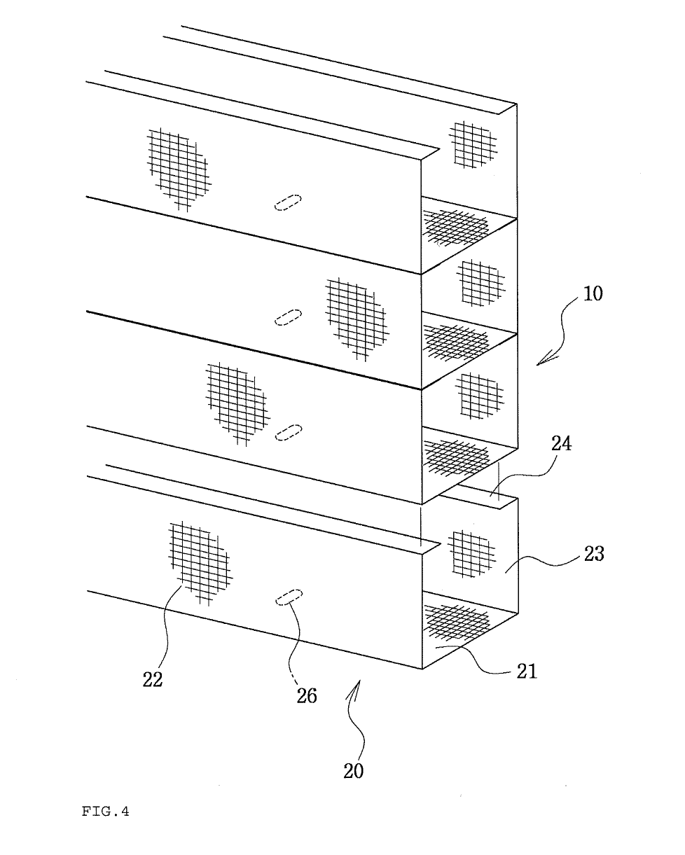

FIG. 4 is a perspective view illustrating unit cells and a blind formed by joining the unit cells according to one embodiment of the present invention. A unit cell 20 of the present invention includes a front translucent portion 22, a rear translucent portion 23, an opaque portion 21 formed between the translucent portions 22 and 23, and joining portions 24 each formed at ends of the translucent portions and 23. Also, a blind 10 of the present invention includes a plurality of unit cells 20 of which the joining portions 24 are bonded to lower portions of the opaque portions 21 by an adhesive.

According to the unit cell 20, as illustrated in FIG. 4, the front translucent portion 22 and the rear translucent portion 23 stand upright, and the joining portions 24 are provided on the ends thereof. Therefore, the joining portions 24 of the unit cell according to the present invention have the same phase or orientation. With the above configuration, the unit cell of the present invention will be easily folded along its center portion. The word “translucent” herein does not exclude purely “transparent”, and the translucent portion is generally made of a mesh.

The blind 10 and/or the unit cell 20 according to the present invention is formed with at least one through-hole 26. More specifically, the unit cell 20 of the present invention has at least one through-hole 26 formed in the opaque portion 21, and the blind 10 consisting of an array of the unit cells has the through-holes 26 continuously formed in a longitudinal direction. A lift cord (not shown) is inserted into the through-holes 26 of the blind 10 according to the present invention, and if the lift cord is pulled, the unit cell 20 of the blind 10 is folded along the center portion due to its self-weight. Accordingly, the blind 10 of the present invention can be folded in order from the lowermost unit cell 20 by operation of the lift cord. As a result, since it is not necessary to wind the blind 10 around an angle adjusting member so as to move the lower end of the blind 10 in an upward direction, the blind assembly of the present invention can be downsized, which will be described in greater detail hereinafter.

According to the present invention, the through-hole 26 can be separately formed in the unit cell 20, or can be formed in the blind 10, which is the array of the unit cells 20, in a lump. The through-hole 26 can be formed by use of a punch, a laser, or the like.

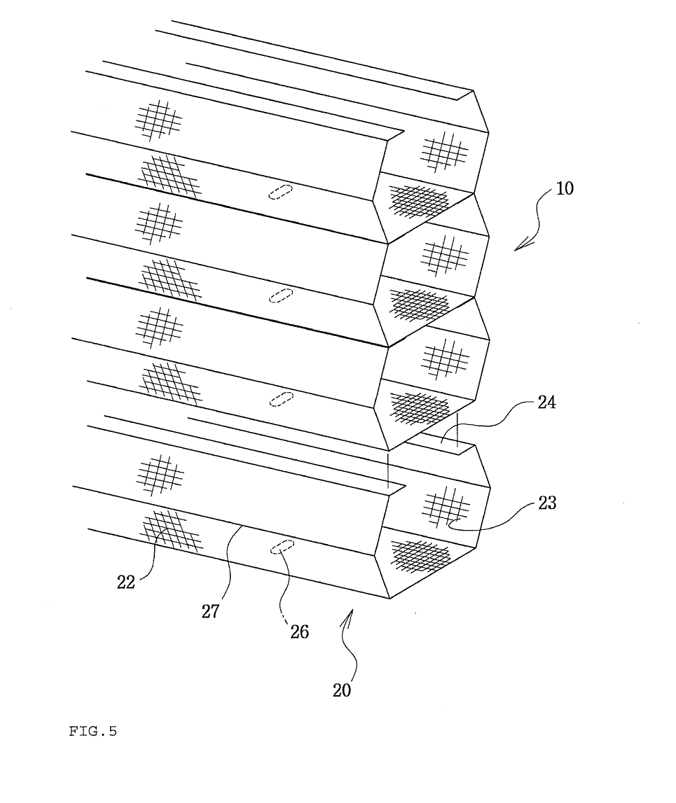

FIG. 5 is a perspective view illustrating unit cells and a blind formed by joining the unit cells according to another embodiment of the present invention. The unit cell 20 of the present invention shown in FIG. 5 is substantially identical to the unit cell 20 shown in FIG. 4, except that folding lines 27 are formed along the center portions of the translucent portions 22 and 23 of the unit cell 20. Also, FIG. 5 shows that the blind 10, which is the array of the unit cells 20, is formed with the folding lines 27.

As described above, a lift cord is inserted into the through-holes 26 of the blind 10 according to the embodiment of the present invention, and if the lift cord is pulled, the unit cell 20 of the blind 10 is folded along the center portion due to its self-weight. However, since the folding lines 27 are formed along the center portions of the unit cell 20, the blind 10 of the present invention can be easily folded along the center portion of the unit cell 20.

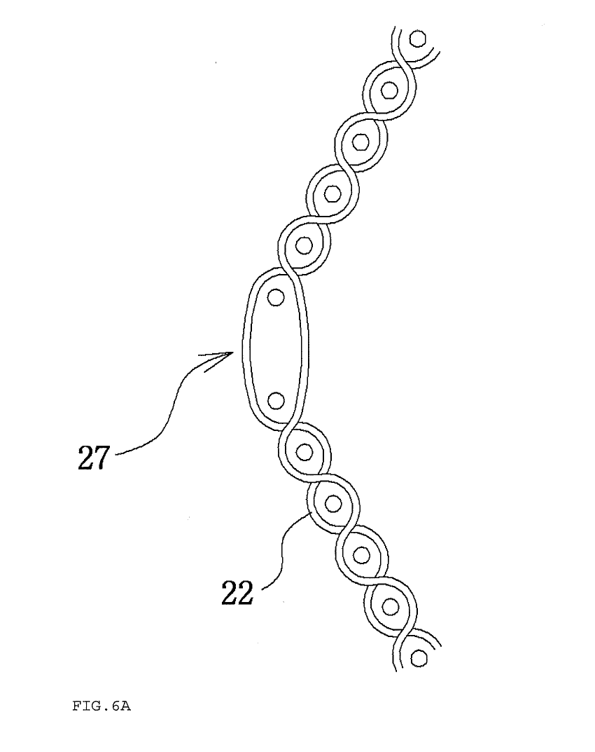

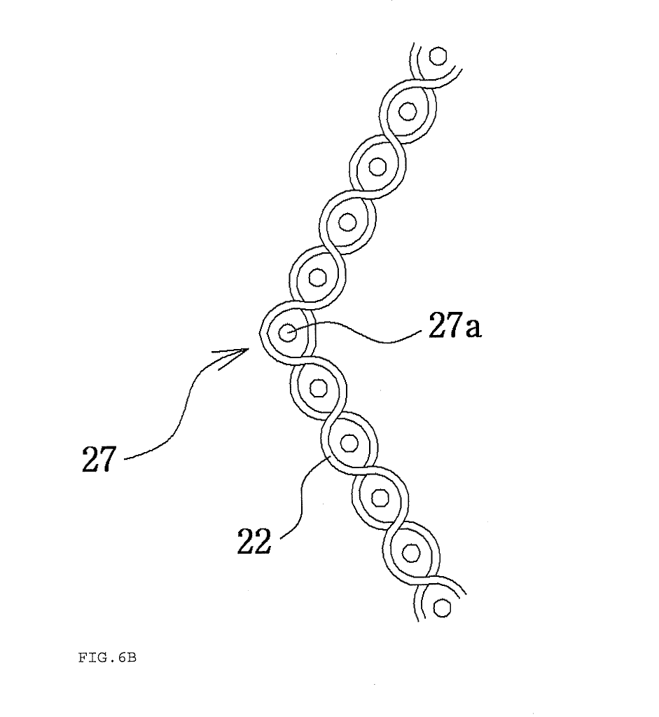

FIGS. 6a and 6b are views illustrating a method of forming the folding lines according to the present invention. The folding line 27 may be formed by skipping a weft yarn at the folding line 27 so that the folding line is outwardly folded, as illustrated in FIG. 6a, or by a material of a thread 27a located at the folding line 27 using a thinner thread than the thread forming the translucent portions 22 and 23 so that the folding line is outwardly folded, as illustrated in FIG. 6b. Alternatively, the folding line 27 may be easily formed by pressing.

The method of fabricating the unit cell 20 according to the present invention will now be described. As described above, the unit cell 20 according to the present invention is divided into one having no folding line 27 at the center portion and one having the folding line 27 at the center line. Since the methods of fabricating the above unit cells are substantially identical, except for the presence or absence of the folding line 27, the method of fabricating the unit cell 20 will now be described in relation to one having the folding line 27 formed at the center portion of the unit cell 20.

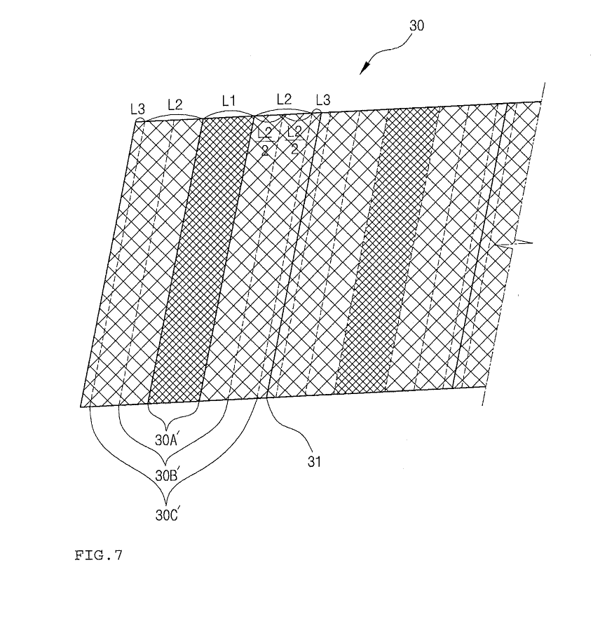

FIG. 7 is a view schematically illustrating the method of fabricating the unit cell according to one embodiment of the present invention. In order to fabricate the unit cell according to the present invention, as illustrated in FIG. 7, a fabric 30 for the blind having the opaque portion and the translucent portion is continuously woven. After that, the fabric 30 for the blind is subjected to a subsequent process, such as dying and heat treatment, and then is cut along a cutting line 31. Subsequently, the cut fabric is bent along boundary lines 30A′, 30B′, and 30C′ to form an opaque portion having L1 in width, translucent portions having L2 in width, and joining portions having L3 in width, thereby fabricating the unit cell.

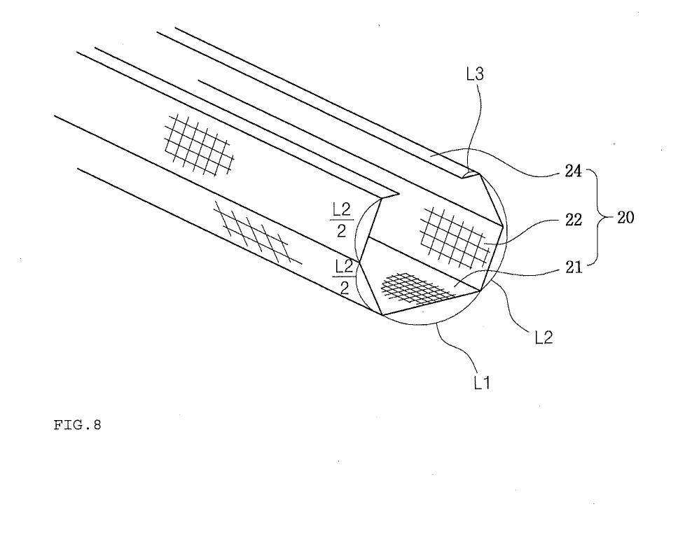

FIG. 8 is a perspective view illustrating a unit cell according to another embodiment of the present invention. Referring to FIG. 8, the unit cell 20 for the blind according to the present invention may include an opaque portion 21, a pair of translucent portions 22 each connected to both ends of the opaque portion 21 and arranged opposite each other with respect to the opaque portion 21, and a pair of joining portions 24 each connected to each end of the pair of opaque portions 22. Reference numeral 23 indicates a component which is substantially identical to that indicated by reference numeral 22, and thus will not be described herein for the purpose of simplification of the explanation.

The opaque portion 21 can be made by (i) overlaying an opaque fabric member on a translucent fabric member forming the translucent portion 22, (ii) performing a film laminating process on the translucent fabric member forming the translucent portion 22, or (iii) performing a printing process on the translucent fabric member forming the translucent portion 22.

The opaque portion 21 made by the above method (i) has a structure in which the opaque fabric member is overlapped with the translucent fabric member, differently from the translucent portion 22 made of only the translucent fabric member, so that penetrating amounts of the light irradiated from the exterior is significantly decreased, as compared to the translucent portion 22. More specifically, since the opaque fabric member has an opening lower than that of the translucent fabric member, light transmissivity is relatively low. Also, since the opaque fabric member is overlapped over the translucent fabric member, the opaque portion 21 shows significantly decreased light transmissivity relative to the translucent portion 22.

Meanwhile, the translucent fabric member and the opaque fabric member can control the light transmissivity by making intersection intervals between weft yarns and warp yarns different or making a thickness of the weft yarn and/or the warp yarn different to vary the opening during manufacture. For example, the translucent fabric member may be made of a mesh-type translucent fabric, and the opaque fabric member may be made of a blackout fabric with a triple sandwiched structure.

The opaque portion 21 made by the above method (ii) may be formed by performing the process of laminating a film substrate, such as a resin film, on the above-described translucent fabric member in a region to form the opaque portion 21, i.e., a film laminating process. In other words, by performing the film laminating process on the desired region of the translucent fabric member, it can achieve the light transmissivity lower than the region which is not subjected to the process.

Also, the opaque portion 21 made by the above method (iii) may be formed by performing the known printing process, such as pigment printing or foaming printing, on some regions of the translucent fabric member. More specifically, apertures of the region to form the opaque portion 21 on the translucent fabric member are filled with a binder contained in pigment ink through the pigment printing, thereby lowering the light transmissivity than that of the region which is not subjected to the printing process. In the case of the foaming printing, after a foaming agent permeates into the apertures of the region to form the opaque portion 21 on the translucent fabric member, the foaming agent is heated and expanded to fill the apertures of the region, thereby forming the opaque portion 21.

The method of fabricating the unit cell for the blind according to the present invention will now be described in detail with reference to the accompanying drawings.

The method of fabricating the unit cell having the opaque portion which is formed by laminating the opaque fabric member on the translucent fabric member according to the embodiment of the unit cell as described above includes a step (a) of weaving and post-processing the opaque fabric and the mesh-type translucent fabric, respectively; a step (b) of cutting the opaque fabric and the mesh-type translucent fabric to have a predetermined size, respectively, to make a rectangular opaque fabric member 41 and a rectangular translucent fabric member 42; a step (c) of laminating the opaque fabric member on the translucent fabric member; and a step (d) of bending the translucent fabric member in the longitudinal direction.

At step (a), the mesh-type translucent fabric and the opaque fabric are respectively woven by making the intersection intervals between the weft yarns and the warp yarns different or making the thickness of the weft yarn and/or the warp yarn different to vary the opening. Then, in order to prevent the respective fabrics from running or giving strength to the respective fabrics, the fabrics are subjected to at least one post-processing which is selected from heat treatment, dyeing, and coating.

At step (b), the opaque fabric and the mesh-type translucent fabric are cut to have a predetermined size according to dimensions of the blind to be fabricated, respectively, to make the rectangular opaque fabric member and the rectangular translucent fabric member.

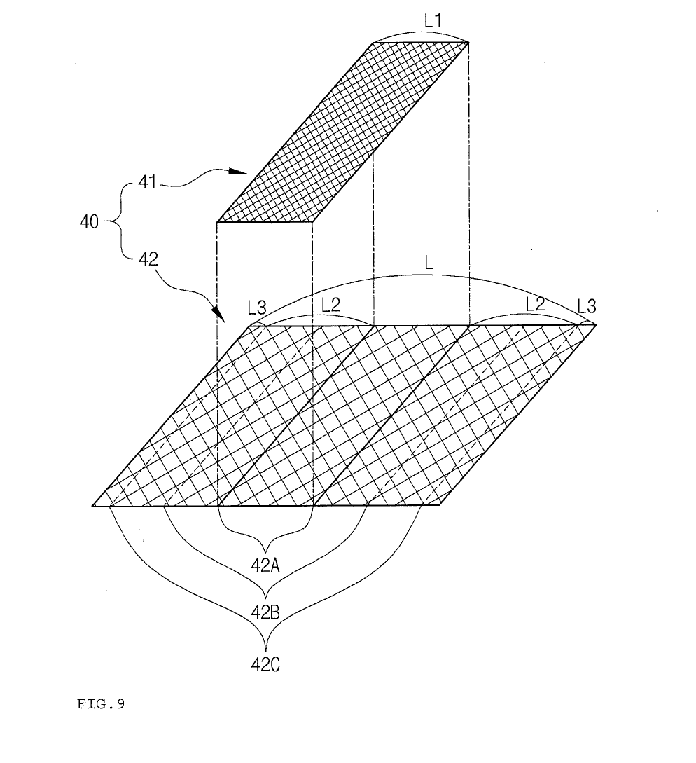

At step (c), as the schematic process is illustrated in FIG. 9, the opaque fabric member 41 is laminated on the center portion of the translucent fabric member 42 in the longitudinal direction to form a unit 40 for fabricating the unit cell. It is preferable to laminate the opaque fabric member 41 on the center portion of the translucent fabric member 42 by an adhesive. For example, after a hot-melt adhesive is applied to one of both surfaces of the opaque fabric member 41 which is brought into contact with the translucent fabric member 42 by dot coating at step (a), the hot-melt adhesive is heated, and then the opaque fabric member 41 is laminated on one surface of the translucent fabric member 42 by hot melting.

Finally, step (d) is to bend the translucent fabric member in the longitudinal direction. Referring to FIG. 9, the translucent fabric member 42 is bent along a bending line 42A and a bending line 42C to form the opaque portion having L1 in width, the translucent portions having L2 in width, and the joining portions having L3 in width. The bending method will be varied upon thickness, strength, or the like of the translucent fabric member. The method can be carried out according to FIGS. 6a and 6b and the description thereof. Also, the method can be simply carried out by pressing.

The unit cell 20 can be formed with a folding line 27 by additionally bending the translucent fabric member 42. For example, if the translucent fabric member is additionally bent along a bending line 42B in FIG. 9, it is possible to fabricate the unit cell 20 in FIG. 8.

In cases where the pair of the translucent portions 22 10, arranged opposite to each other with respect to the opaque portion 21 in the unit cell according to the present invention are different in color, the unit cell can be used to fabricate the blind having a front portion and a rear portion which are different in color.

Although the unit cell having the translucent portions of different colors can be fabricated by use of one mesh-type translucent fabric of which the respective portions to form the translucent portion are different in color, it is preferable to use two mesh-type translucent fabrics of different colors, in view of a reduced cost of the weaving process and simplification thereof.

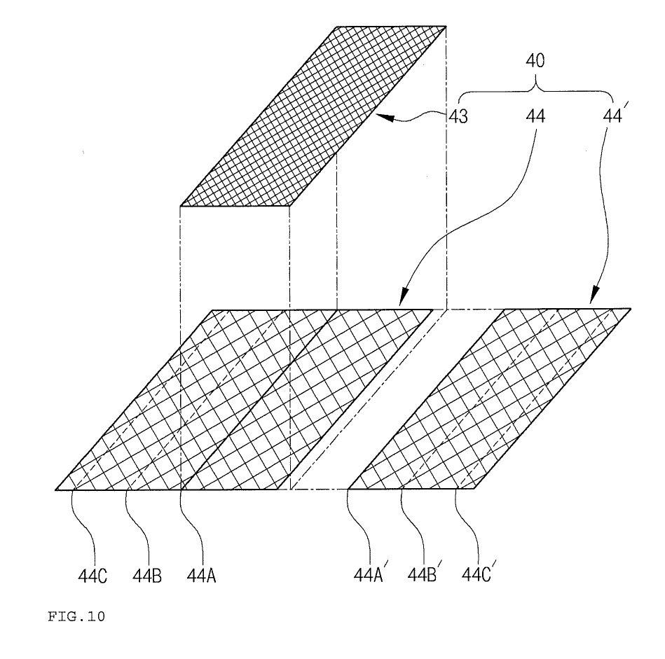

More specifically, as illustrated in FIG. 10, the translucent fabric member 44 having a portion bonded to the opaque fabric member 43 and having a desired color, and a translucent fabric member 44′ having a color different from the color of the translucent fabric member are prepared. A boundary line 44A′ of the translucent fabric member 44′ is bonded to an edge of the translucent fabric member 44, thereby forming a translucent fabric member having a translucent forming region of a different color. And, the opaque fabric member 43 is laminated on the translucent forming region, thereby obtaining the unit 40 for fabricating the unit cell. After that, the unit cell having the translucent portion of the different color can be fabricated by performing the bending process, like step (d) described above.

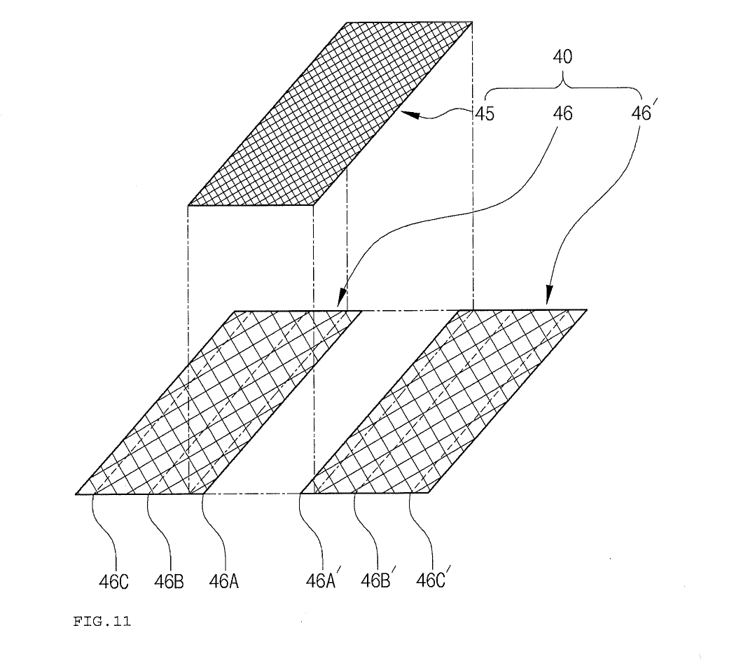

As illustrated in FIG. 11, the unit 40 for fabricating the unit cell can be obtained by bonding the opaque fabric member 45 to the translucent fabric member 46 of a desired color and a translucent fabric member 46′ of a different color along a boundary line 46A and a boundary line 46A′. After that, the unit cell having the translucent portion of the different color can be fabricated by performing the bending process, like step (d) described above.

The method of fabricating the unit cell having the opaque portion which is formed by performing the film laminating process on the translucent fabric member to form the translucent portion according to another embodiment of the unit cell as described above includes a step (a) of weaving and post-processing the translucent fabric; a step (b) of cutting the translucent fabric to have a predetermined size to make a rectangular translucent fabric member 48; a step (c) of performing a film laminating process on a desired region of the translucent fabric member; and a step (d) of bending the translucent fabric member in the longitudinal direction.

At step (a), a translucent fabric having high light transmissivity, such as a mesh-type translucent fabric, is made, and then, in order to prevent the fabric from running and giving strength to the fabric, the fabric is subjected to at least one post-processing which is selected from heat treatment, dyeing, and coating.

At step (b), the translucent fabric is cut to have a predetermined size according to dimensions of the blind to be fabricated to make the rectangular translucent fabric member 48.

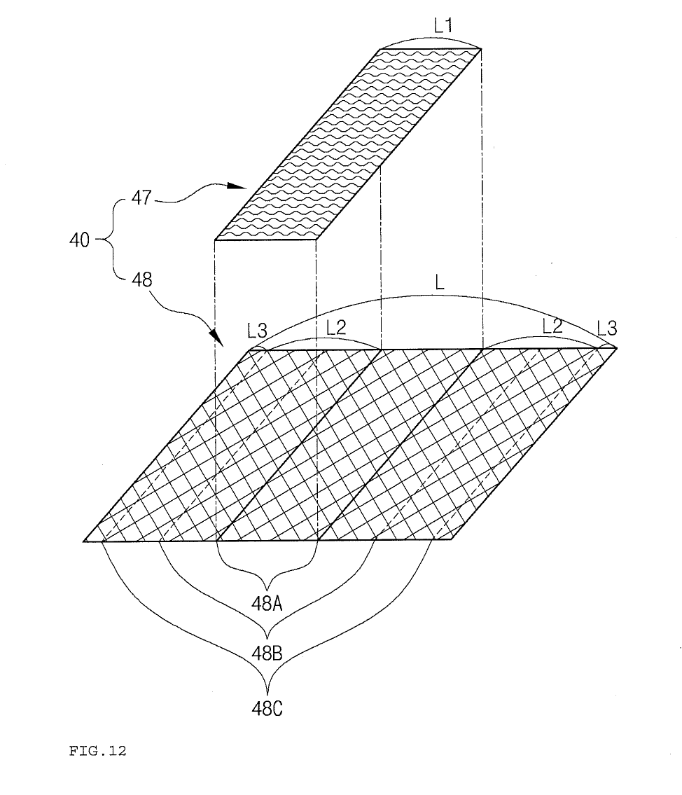

At step (c), as illustrated in FIG. 12, the translucent fabric member 48 is subjected to a process of laminating a film substrate 47, such as a resin film, on a center portion thereof along the longitudinal direction, i.e., the film laminating process, thereby forming the opaque portion.

Finally, step (d) is to bend the translucent fabric member in the longitudinal direction. Referring to FIG. 12, the translucent fabric member 48 is bent along a bending line 48A and a bending line 48C to form the opaque portion having L1 in width, the translucent portions having L2 in width, and the joining portions having L3 in width. The bending method will be varied upon thickness, strength, or the like of the translucent fabric member. The method can be carried out according to FIGS. 6a and 6b and the description thereof. Also, the method can be simply carried out by pressing.

The unit cell can be formed with a folding line 27 by additionally bending the translucent fabric member 48. For example, if the translucent fabric member is additionally bent along a bending line 48B in FIG. 12, it is possible to fabricate the unit cell 20 in FIG. 8.

The method of fabricating the unit cell having the opaque portion which is formed by performing the printing process on the translucent fabric member to form the translucent portion according to another embodiment of the unit cell as described above includes a step (a) of weaving and post-processing the translucent fabric; a step (b) of cutting the translucent fabric to have a predetermined size to make a rectangular translucent fabric member 50; a step (c) of performing a printing process on a desired region of the translucent fabric member; and a step (d) of bending the translucent fabric member in the longitudinal direction.

At step (a), a translucent fabric having high light transmissivity, such as a mesh-type translucent fabric, is made, and then, in order to prevent the fabric from running and giving strength to the fabric, the fabric is subjected to at least one post-processing which is selected from heat treatment, dyeing, and coating.

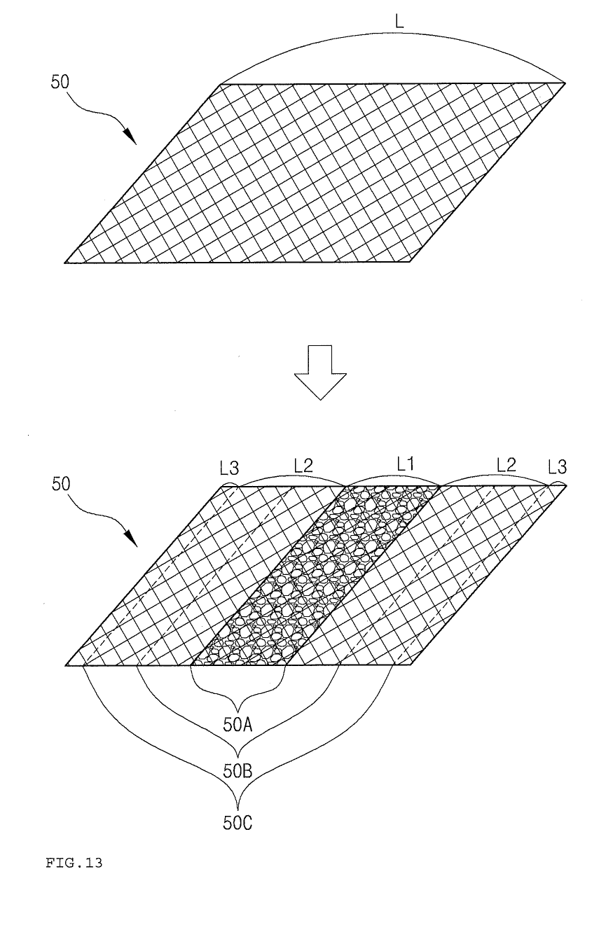

At step (b), the translucent fabric is cut to have a predetermined size according to dimensions of the blind to be fabricated to make the rectangular translucent fabric member 50, as illustrated in the top drawing of FIG. 13.

At step (c), as illustrated in the bottom drawing of FIG. 13, the translucent fabric member 50 is subjected to the known printing process, such as pigment printing or foaming printing, on the center portion of the translucent fabric member 50 along the longitudinal direction to form the opaque portion, as illustrated in the bottom drawing of FIG. 13.

More specifically, apertures of the region to form the opaque portion on the translucent fabric member are filled with a binder contained in pigment ink through the pigment printing, thereby forming the opaque portion having the light transmissivity significantly lower than that of the region which is not subjected to the printing process. In the case of the foaming printing, after a foaming agent permeates into the apertures of the region to form the opaque portion on the translucent fabric member, the foaming agent is heated and expanded to fill the apertures of the region, thereby forming the opaque portion 21 having the light transmissivity significantly lower than that of the region which is not subjected to the printing process. The pigment printing or the foaming printing is preferably performed by employing a proper coating method among the known coating methods, such as gravure coating or knife coating, to apply a composition for the pigment printing or a composition for the foaming printing onto the translucent fabric member.

Finally, step (d) is to bend the translucent fabric member in the longitudinal direction. Referring to FIG. 13, the translucent fabric member 50 is bent along a bending line 50A and a bending line 50C to form the opaque portion having L1 in width, the translucent portions having L2 in width, and the joining portions having L3 in width. The bending method will be varied upon thickness, strength, or the like of the translucent fabric member. The method can be carried out according to FIGS. 6a and 6b and the description thereof. Also, the method can be simply carried out by pressing.

The unit cell can be formed with a bending line 27 by additionally bending the translucent fabric member 50. For example, if the translucent fabric member is additionally bent along a bending line 50B in FIG. 13, it is possible to fabricate the unit cell 20 in FIG. 8.

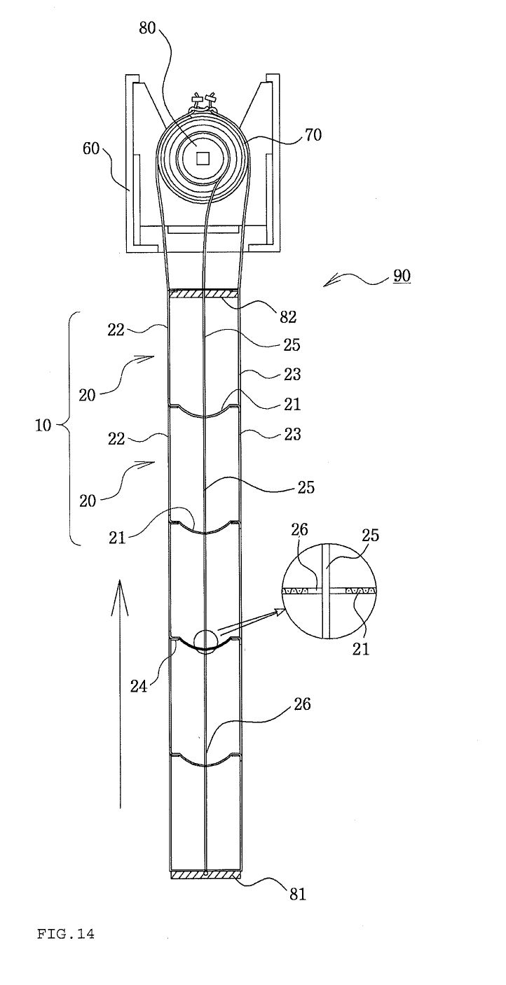

The blind assembly according to the present invention will now be described. FIG. 14 is a longitudinal cross-sectional view schematically illustrating the blind assembly using the blind according to one embodiment of the present invention. Referring to FIG. 14, a blind assembly 90 of the present invention includes a frame 60 and an angle adjusting member 70 installed in the frame so that the angle adjusting member can be rotated to a right or left side by an angle of about 90 degrees. The angle adjusting member 70 is rotated in the left or right side by a known driving device (not shown) to relatively move the front translucent portion 22 and the rear translucent portion 23 of the blind 10. Also, a drum 80 installed in the angle adjusting member 70 raises or lowers the blind by use of the driving device. The frame 60 is fixed to a wall or a window frame, thereby fixing the blind thereto.

As illustrated in FIG. 14, upper ends of the rear translucent portion 22 and the rear translucent portion 23 of the blind 10 are attached to the angle adjusting member 70 to have a phase difference of about 180 degrees. According to a preferred embodiment of the present invention, the center portions of the front translucent portion 22 and the rear translucent portion 23 may be provided with a folding line so that the unit cell can be easily folded by the self-weight thereof. The opaque portion 21 positioned between the front translucent portion 22 and the rear translucent portion 23 is formed with at least one through-hole 26 through which a lift cord 25 passes. The lift cord 25 passes through the through-hole 26, with one end being fixed to the drum 80, and the other end being fixed to a weight 81. The lift cord is preferably made of a transparent or translucent material so as not to be seen by a user. Even though one though-hole is formed, there is no problem theoretically. Two or more through-holes are preferably formed to horizontally maintain the unit cell or easily lift it.

The blind 10 joining the unit cells 20 includes the weight 81 attached to a lower surface of the lowermost unit cell 20, and a parallel maintaining plate 82 attached to the uppermost unit cell 20. The weight 81 is to maintain the blind in a tension state, and the parallel maintaining plate 82 is to allow the front translucent portion 22 and the rear translucent portion 23 of the unit cell to perform relative movement smoothly when the angle adjusting member 70 rotates. Also, since the joining portions 24 of the unit cell are bonded to the opaque portion 21 of another unit cell to form the blind of the present invention, the opaque portion sags due to the self-weight thereof when the unit cell is maintained in the horizontal state. The sagging amount can be varied depending upon the method of forming the opaque portion and the material thereof.

The operation of the blind assembly according to the present invention will now be described. As illustrated in FIG. 14, in the state in which the lift cord 25 is fully unwound from the drum 80, that is, the lower end of the blind is positioned at the bottom dead point, the unit cells 20 are maintained in the horizontal state. In this instance, since the front translucent portion 22 and the rear translucent portion 23 of the unit cell are spaced apart from each other by the opaque portion 21, the light and the fresh air flow through the translucent portions from the exterior. If the angle adjusting member 70 is rotated at an angle of 90 degrees by pulling an adjusting cord (not shown) in order to block the light, the front translucent portion 22 moves downwardly, and the rear translucent portion 23 moves upwardly. In other words, the front translucent portion and the rear translucent portion perform relative movement. Then, the front translucent portion 22 of the upper unit cell is brought almost into contact with the rear translucent portion 23 of the lower unit cell adjacent to the front translucent portion 22 of the upper unit cell, thereby blocking the light by the opaque portion 21 positioned between the translucent portions.

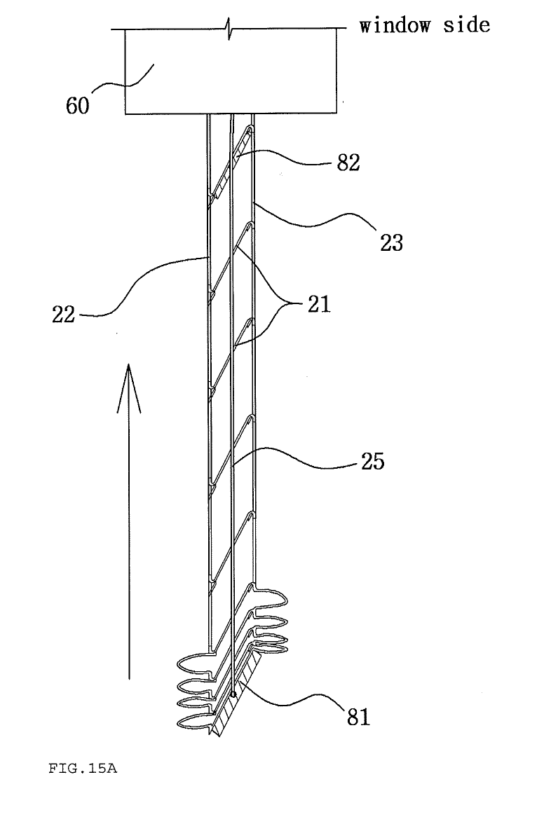

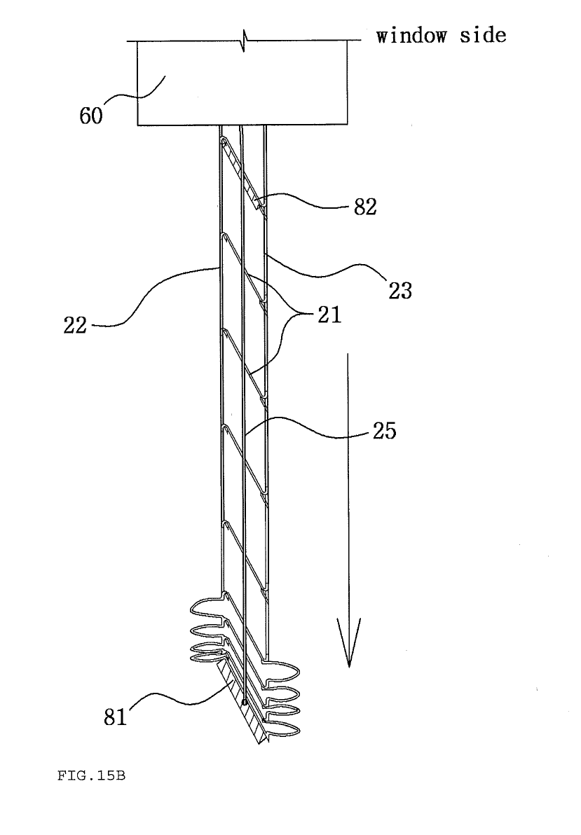

FIGS. 15a and 15b are views schematically illustrating lifting and lowering operation of the blind assembly according to one embodiment of the present invention. First, referring to FIG. 15a, if the user further pulls the adjusting cord in the state of blocking the light, the drum 80 is rotated to wind the lifting cord 25 around the drum 80, and thus the blind moves up. Thus, the unit cells of the blind are folded along the center portion in order from the lowermost unit cell, and then are overlapped with each other. In the case where the folding line 27 is formed at the center portions of the translucent portions of the blind according to the present invention, the lower unit cell is easily folded and overlapped with each other in order from the lowermost unit cell, relative to the upper cell.

As illustrated in FIG. 15a, in order to pass the light in the state in which the blind is raised to a certain extent, the user pulls the adjusting cord in an opposite direction to rotate the angle adjusting member 70 in the opposite direction, so that the unfolded unit cells are maintained in the horizontal state.

The blind according to the present invention can be raised until the lift cord 25 is fully wound around the drum 80. Since the lower unit cells of the blind according to the present invention are overlapped with each other, the blind is not wound around the roller. Accordingly, it is possible to raise the blind more quickly than a type of blind which is wound around the roller. Also, since the volume of the frame accommodating the roller therein can be decreased, it is possible to downsize the blind assembly.

If the blind moves down in the state in which the blind is fully raised, the operation of the adjusting cord is carried out in order reverse to the case where the blind is raised. As illustrated in FIG. 15b, the unit cells of the blind are spread out in order from the uppermost unit cell. In the spreading state, the adjusting cord can be operated to horizontally position the unit cells, thereby passing the light.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A unit cell for a blind, comprising:
an opaque portion;
a pair of translucent portions which are respectively connected to both ends of the opaque portion and arranged opposite each other with respect to the opaque portion; and
a pair of joining portions which are respectively connected to each end of the pair of translucent portions,
wherein the translucent portions of the unit cell are foldable along a substantially center portion thereof.

2. The unit cell for the blind according to claim 1, wherein the opaque portion is formed by laminating an opaque fabric member on a translucent fabric member.

3. The unit cell for the blind according to claim 1, wherein the opaque portion is formed by performing a film laminating process on a translucent fabric member.

4. The unit cell for the blind according to claim 1, wherein the opaque portion is formed by performing a printing process on a translucent fabric member.

5. The unit cell for the blind according to claim 4, wherein the printing process is at least one of a pigment printing process and a foaming printing process.

6. The unit cell for the blind according to claim 1, wherein the translucent portions are made of a translucent fabric member, the opaque portion is made of an opaque fabric member, and
Wherein the translucent fabric member and the opaque fabric member are made of weft yarns and/or warp yarns of different intersection intervals and/or a different thickness.

7. The unit cell for the blind according to claim 1, wherein the joining portions of the unit cell are bonded to an opaque portion of another unit cell.

8. The unit cell for the blind according to claim 1, wherein the translucent portions of the unit cell have a folding line at the substantially center portion thereof so that the translucent portion is easily folded.

9. The unit cell for the blind according to claim 8, wherein the folding line is formed by pressing.

10. The unit cell for the blind according to claim 8, wherein the folding line is formed by skipping a weft yarn.

11. The unit cell for the blind according to claim 8, wherein the folding line is formed by weaving a thread thinner than that of the translucent portion.

12. A blind capable of adjusting a horizontal angle comprising:
a plurality of unit cells,
each unit cell including:
an opaque portion;
a pair of translucent portions which are respectively connected to both ends of the opaque portion and arranged opposite each other with respect to the opaque portion; and
a pair of joining portions which are respectively connected to each end of the pair of translucent portions,
wherein the blind is formed by bonding the joining portions of the unit cell to an opaque portion of another unit cell,
wherein an angle of the opaque portion is adjusted in a horizontal direction by relative movement between the pair of translucent portions, and
wherein when the blind is raised the translucent portions of the unit cells are folded along a substantially center portion thereof and the unit cells are stacked in order from the lowermost unit cell.

13. The blind according to claim 12, wherein the translucent portions of the unit cell have a folding line at the substantially center portion thereof so that the translucent portions are easily folded.

14. A blind assembly comprising:
a blind;
a frame for mounting the blind;
an angle adjusting member and a drum which are installed to an inside of the frame; and
a driving device for driving the angle adjusting member and the drum,
the blind including a plurality of unit cells,
each unit cell comprising: an opaque portion, a pair of translucent portions which are respectively connected to both ends of the opaque portion and arranged opposite each other with respect to the opaque portion, and a pair of joining portions which are respectively connected to each end of the pair of translucent portions,
wherein the blind is formed by bonding the joining portions of the unit cell to an opaque portion of another unit cell,
wherein an angle of the opaque portion is adjusted in a horizontal direction by relative movement between the pair of translucent portions, and
wherein when the blind is raised the translucent portions of the unit cells are folded along a substantially center portion thereof and the unit cells are stacked in order from the lowermost unit cell.

15. The blind assembly according to claim 14, wherein the opaque portion of the unit cell is formed with a through-hole through which a lift cord passes.

16. The blind assembly according to claim 15, wherein the opaque portion of the unit cell has at least two through-holes.

17. The blind assembly according to claim 14, wherein the translucent portions of the unit cell have a folding line at the substantially center portion thereof so that the translucent portions are easily folded.
